(19) United States
(12) Patent Application Publication
(10) Pub. No.: US 2009/0241848 A1
(43) Pub. Date: Oct. 1, 2009

(54) Animal Waterer

(76) Inventor: Dennis Bryant, Loganville, GA (US)

Correspondence Address: MERCHANT & GOULD PC, P.O. BOX 2903, MINNEAPOLIS, MN, 55402-0903, US

(21) Appl. No.: 12/057,488

(22) Filed: Mar. 28, 2008

(51) Int. Cl. A01K 7/00

(52) U.S. Cl. 119/73; 119/74; 119/78

(57) ABSTRACT

An animal waterer may be provided. The animal waterer may comprise a reservoir for containing a water supply, a sediment container located in the reservoir and in fluid communication with the water supply, and a drinking container located in the sediment container. The drinking container may comprise at least one opening in fluid communication with the water supply. The animal waterer may also comprise a valve in fluid communication with the reservoir.

### BACKGROUND

Animal waterers are used to supply animals with water. Animal waterers may be fashioned in various ways. For example, conventional animal waterers may comprise a trough or other container for holding water. In addition, they may be heated such that the water in the waterer does not freeze. However, conventional waterers do not allow an ample amount of continuous clean heated or non-heated water supply with minimal energy consumption and heat loss or heat gain. In addition, cleaning the conventional waterers requires considerable time and large amounts of water are wasted because conventional waterers must be drained before, and during cleaning and then refilled.

### SUMMARY OF THE INVENTION

Consistent with embodiments of the present invention an animal waterer may be provided. The waterer may comprise a reservoir for containing a water supply, a sediment container located in the reservoir and in fluid communication with the water supply, and a drinking container located in the sediment container. The drinking container may comprise at least one opening in fluid communication with the water supply. The animal waterer may also comprise a valve in fluid communication with the reservoir.

Both the foregoing general description and the following detailed description are examples and explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 shows a schematic of an animal waterer; and

FIG. 2 shows a schematic of an animal waterer.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

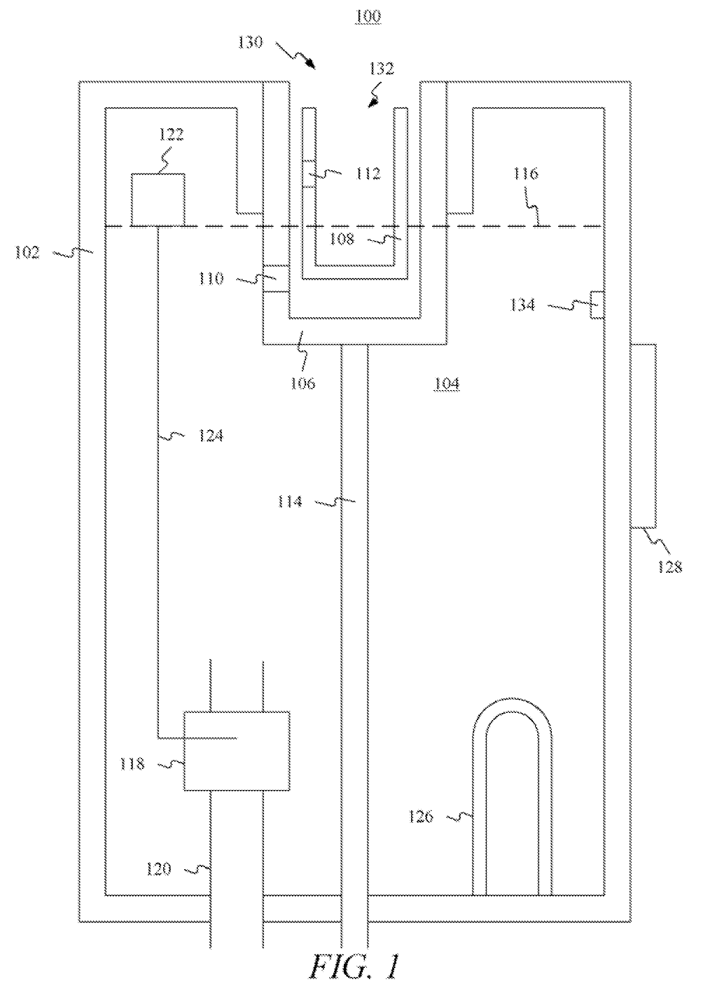

FIG. 1, shows an animal waterer 100. Consistent with embodiments of the present invention, animal waterer 100 may comprise a reservoir 102 for containing a water supply 104, a sediment container 106, and a drinking container 108. Reservoir 102 may comprise an upper aperture 130 for allowing an animal access to drinking container 108.

Consistent with embodiments of the invention, reservoir 102 may be sized, for example, on the size and/or number of animals to be watered. Examples of various size reservoirs may include 1-1,000 gallon containers. For example, reservoir 102 may be a 20 gallon tank, a 55 gallon drum, or a 5 gallon container.

Sediment container 106 may be located in reservoir 102 such that fluids may flow between sediment container 106 and reservoir 102 (i.e. sediment container 106 may be in fluid communication with reservoir 102). Sediment container 106 may comprise at least one hole 110 to allow a portion of water supply 104 to enter sediment container 106. The location of hole 110 may be on sediment container 106's sides or bottom. Hole 110 may allow water to flow from reservoir 102 into sediment container 106. Hole 110 may include a mesh screen or other filter to hinder sediment or other contaminates from entering reservoir 102 and contaminating water supply 104. Sediment container 106 may also comprise a drain 114. Drain 114 may be used to drain water located in sediment container 106 without having to drain water supply 104 from reservoir 102. Drain 114 may be sealed with a valve or rubber stopper.

Drinking container 108 may be located in sediment container 106 and in fluid communication with the portion of water supply 104 located in sediment container 106. Drinking container 108 may comprise a drinking aperture 132 and at least one hole 112 to allow the portion of water supply 104 located in sediment container 106 to flow into drinking container 108. Hole 112 may include a mesh screen or other filter to hinder sediment and other contaminates from entering sediment container 106 and contaminating water located in sediment container 106. Hole 112 may be located on drinking container 108's sides or bottom. Hole 112 may allow water to flow from sediment container 106 into drinking container 108. Drinking container 108 may also be configured to be removable from sediment container 106 to allow drinking container to be cleaned without having to drain water supply 104 from reservoir 102. In addition, removing drinking container 108 from sediment container 106 may facilitate cleaning sediment container 106 without the need to drain reservoir 102.

Drinking container 108 may also be buoyant. Consistent with embodiments of the invention, when drinking container 108 is buoyant, an animal (e.g. a horse) may press drinking container 108 down into water located in sediment container 106 to allow water to flow into drinking container 108. For example, when drinking container 108 contains a first amount of water, hole 112 may be located above a water line 116. When the animal drinks, the animal may press drinking container 108 such that hole 112 travels below water line 116 and allows water to flow from sediment container 106 into drinking container 108.

Animal waterer 100 may also comprise a valve 118 in fluid communication with reservoir 102. Valve 118 may be connected to a water supply (e.g. a well or a tap) to allow fresh water to enter reservoir 102 via pipe 120. Valve 118 may also include a float bulb 122 connected to valve 118 via a cord or rod 124. Float bulb 122 may rise and fall with water line 116. When water line 116 recedes to a first predetermined level, valve 118 may open and allow fresh water to enter reservoir 102. When water line 116 rises to a second predetermined level, valve 118 may close and stop water from flowing into reservoir 102. Examples of possible valves may include, but are not limited to, a check valve, a float valve, and a ball valve.

While FIG. 1 shows that valve 118 may be located inside reservoir 102, valve 118 may be located outside animal waterer 100. For example, valve 118 may be secured to animal waterer 100's sides. In addition, valve 118 may be mounted in a separate location from animal waterer 100. For instance, valve 118 may be an electronically controlled valve and reservoir 102 may include an electronic sensor to monitor water line 116's location. When water line 116 recedes to a certain point, the electronic sensor may send a signal to valve 118 that may open and allow water to flow into reservoir 102. When water supply 104 is replenished, the electronic sensor may send a second signal to valve 118 halting water flow into reservoir 102.

Reservoir 102 may be insulated. Insulating reservoir 102 may help prevent water supply 104 from freezing and/or help maintain water supply 104's temperature. For example, animal waterer 100 may include a heater 126. Consistent with embodiments of the invention, heater 126 may be used to heat water supply 104 in winter months. Furthermore, heater 126 may be used to heat water to a desired temperature. For example, a thermostat 134 may be located in reservoir 102 to measure water supply 104's temperature. Heater 126 may be used such that water supply 104's temperature remains relatively constant at 65 degrees or any other temperature.

Animal waterer 100 may also include a control panel 128 mounted to or separate from reservoir 102. Control panel 128 may contain indicator lights to notify a user when heater 126 is active. In addition, control panel 128 may contain other indicators. For instance animal waterer 100 may include a contaminate sensor (not shown) that may notify the user that water supply 104 has reached a certain contaminate level. Consequently, the user may clean animal waterer 100. Control panel 128 may also contain fuses and/or circuit breakers to shut off power to heater 126 should there be a problem such as heater 126 being defective or water supply 104 being to low.

In addition, control panel 128 may contain a control device (e.g. a computer, a programmable controller, etc.) (not shown) to control animal waterer 100. For example, the programmable controller may only allow heater 126 to operate during specific time periods (e.g. at night, during the day, from noon to 5:00 PM, etc.). The control device may also control a valve (not shown) located on drain 114 and/or reservoir 102. For example, the control device may have a cleaning cycle program. When the cleaning cycle program runs, the valve located on drain 114 and/or reservoir 102 may open allowing water to flow from sediment container 106 and/or reservoir 102. As the water flows from animal waterer 100 fresh water may enter through valve 118. As a result, animal waterer 100 may flush itself.

Power to run any controllers and/or heater 126 can be delivered via a standard 120 or 240 volt outlet. Depending on power requirements (i.e. animal waterer 100's size and capacity) animal water may be hard wired and/or have a dedicated circuit and/or may simply be plugged into an outlet. Also depending on animal waterer 100's size, it may be portable and/or a built-in unit. For example, if animal waterer 100 is used in a large stable, multiple units may be used (i.e. built off-site and delivered and installed), or a single unit can be constructed on-sight.

### EXAMPLE ONE

An example of animal waterer 100's operation may be as follows. A horse may drink water from drinking container 108. As this happens, the horse may press drinking container 108 into sediment container 106. As a result, water may flow through hole 112 to replace what the horse drank. When water flows from sediment container 106 to drinking container 108, water may also flow from reservoir 102 to sediment container 106 through hole 110 to replenish the water in both drinking container 108 and sediment container 106. Water supply 104 may be heated by heater 126 that may be, for example, a 2,000 watt heating element. Holes 110 and 112 may be covered with a 30 micron pleated filter to help hinder sediment and other contaminates from flowing into water supply 104.

When a user wishes to clean animal waterer 100, the user may remove drinking container 108 and clean it. Due to the aforementioned filters, very little sediment or other contaminates may have entered sediment container 106. Consequently, only drinking container 108 may need to be cleaned. Over time, sediment and other contaminates may accumulate in sediment container 106. When this happens, the user may remove drinking container 108 and clean both drinking container 108 and sediment container 106. For example, the user may open a valve or unplug drain 114 and rinse any accumulated sediment or contaminates from sediment container 106.

While the user is cleaning sediment container 106, the user may plug hole 110 to prevent water from water supply 104 from entering sediment container 106. The user may also disconnect animal waterer 100 from its water supply (e.g. well water or tap water) such that water supply 104 is not replenished when water flows from water supply 104 into sediment container 106.

Once sediment container 106 and/or drinking container 108 are cleaned the user may reinstall the plug and/or close the valve on drain 114, and replace drinking container 108. After animal waterer 100 is reconnected to its water supply or hole 110 is unplugged, water may flow from water supply 104 into sediment container 106 and into drinking container 108 and animal waterer 100 is ready for use.

### EXAMPLE TWO

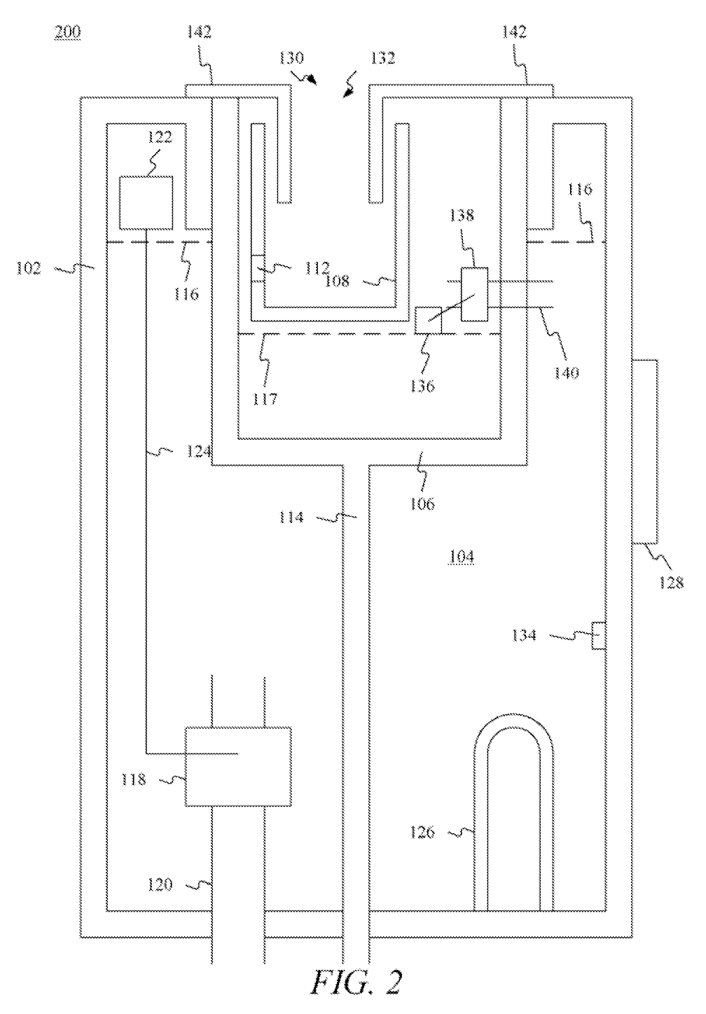

FIG. 2 shows another example of how an animal waterer 200 may operate. A horse may drink water from drinking container 108. As this happens, the horse may press drinking container 108 into sediment container 106. As a result, water may flow through hole 112 to replace what the horse drank. When water flows from sediment container 106 to drinking container 108, float 136 may sink and activate a valve 138. When valve 138 is activated water may also flow from reservoir 102 to sediment container 106 through a pipe 140 to replenish the water in both drinking container 108 and sediment container 106.

When the horse is not drinking from drinking container 108, drinking container 108 may float on water located in sediment container 106 as indicated by a water line 117. As drinking container 108 floats on water line 117, water in drinking container 108 may drain from drinking container 108 to sediment container 106.

Water supply 104 may be heated by heater 126 that may be, for example, a 2,000 watt heating element. Hole 112 may be covered with a 30 micron stainless steel mesh filter to help hinder sediment and other contaminates from flowing into water supply 104.

When a user wishes to clean animal waterer 200, the user may remove a locking ring 142 and drinking container 108 for cleaning. Due to the aforementioned filter, very little sediment or other contaminates may have entered sediment container 106. Consequently, only drinking container 108 may need to be cleaned. Over time, sediment and other contaminates may accumulate in sediment container 106. When this happens, the user may remove drinking container 108 and clean both drinking container 108 and sediment container 106. For example, the user may open a valve or unplug drain 114 and rinse any accumulated sediment or contaminates from sediment container 106.

While the user is cleaning sediment container 106, the user may plug hole 110 to prevent water from water supply 104 from entering sediment container 106. The user may also disconnect animal waterer 200 from its water supply (e.g. well water or tap water) such that water supply 104 is not replenished when water flows from water supply 104 into sediment container 106.

Once sediment container 106 and/or drinking container 108 are cleaned the user may reinstall the plug and/or close the valve on drain 114, and replace drinking container 108. After animal waterer 200 is reconnected to its water supply, water may flow from water supply 104 into sediment container 106 and when the horse presses drinking container 108, valve 138 may allow water to flow and animal waterer 200 is ready for use.

While certain embodiments of the invention have been described, other embodiments may exist. The invention's scope is indicated by the following claims. Furthermore, while the specification has been described in language specific to structural features and/or methodological acts, the claims are not limited to the features or acts described above. Rather, the specific features and acts described above are disclosed as examples for embodiments of the invention.

What is claimed is:

1. An animal waterer comprising:
a reservoir configured to contain a water supply;
a sediment container located in the reservoir, the sediment container being configured to be in fluid communication with the reservoir;
a drinking container located in the sediment container, the drinking container comprising at least one opening in fluid communication with the sediment container; and
a valve in fluid communication with the reservoir.

2. The animal waterer of claim 1, wherein the reservoir is thermally insulated.

3. The animal waterer of claim 1, wherein the sediment container is configured to be drained without draining the reservoir.

4. The animal waterer of claim 1, wherein the valve comprises a float configured to be used to control an amount of water in the reservoir.

5. The animal waterer of claim 1, wherein the drinking container is configured to be removed from the sediment container.

6. The animal waterer of claim 1, further comprising a heater configured to heat the water supply in the reservoir.

7. The animal waterer of claim 6, wherein the heater is configured to maintain the water supply within a predetermined temperature range.

8. The animal waterer of claim 1, wherein the sediment container is configured to be cleanable without having to empty the water supply from the reservoir.

9. The animal waterer of claim 1, wherein the sediment container comprises a drain configured to allow a sediment container water supply to be drained without having to drain the reservoir.

10. The animal waterer of claim 1, wherein the valve is located inside the reservoir.

11. An animal waterer comprising:
a reservoir configured to contain a water supply;
a sediment container located in the reservoir, the sediment container being configured to be in fluid communication with the reservoir and configured to contain a sediment container water supply;
a buoyant drinking container located in the sediment container and comprising at least one opening in fluid communication with the sediment container, wherein the at least one opening is above a sediment container water line when the buoyant drinking container contains a first water amount; and
a valve in fluid communication with the reservoir.

12. The animal waterer of claim 11, wherein the reservoir is thermally insulated.

13. The animal waterer of claim 11, wherein the sediment container is configured to be drained without draining the reservoir.

14. The animal waterer of claim 11, wherein the valve comprises a float, configured to be used to control an amount of water in the reservoir.

15. The animal waterer of claim 1, wherein the buoyant drinking container is configured to be removed from the sediment container.

16. The animal waterer of claim 11, further comprising a heater configured to heat the water supply when the water supply is in the reservoir.

17. The animal waterer of claim 16, further comprising a heater configured to maintain the water supply within a predetermined temperature range.

18. The animal waterer of claim 11, wherein the sediment container is configured to be cleanable without having to empty the water supply from the reservoir.

19. The animal waterer of claim 11, wherein the sediment container comprises a drain configured to allow the sediment container water supply to be drained without having to drain the reservoir.

20. An animal waterer comprising:
a reservoir for containing a water supply, the reservoir defining an upper aperture;
a first valve having a first valve inlet for receiving the water supply and a first valve outlet for diverting the water supply into the reservoir;
a sediment container disposed in the reservoir so as to be in fluid communication with the upper aperture, the sediment container configured for receiving and containing at least a portion of the water supply as a sediment container water supply;
a second valve in fluid communication between the sediment container and the reservoir, the second valve having a second valve inlet for receiving the reservoir water supply and a second valve outlet for diverting the reservoir water supply into the sediment container;
a buoyant drinking container located in the sediment container, the drinking container defining a drinking aperture in the upper aperture, the drinking container configured to be removable from the sediment container through the upper aperture;
a filter device in fluid communication with the drinking container so as to allow at least a portion of the sediment container water supply to flow through the filter and into the drinking container; and
a heater configured to heat the water supply.
